(19) United States
(12) Patent Application Publication
(10) Pub. No.: US 2024/0409094 A1
(43) Pub. Date: Dec. 12, 2024

(54) DELIVERY MANAGEMENT SYSTEM, DELIVERY MANAGEMENT APPARATUS, AND DELIVERY MANAGEMENT METHOD

(71) Applicant: NEC Corporation, Minato-ku, Tokyo (JP)

(72) Inventor: Tomoaki TANAKA, Tokyo (JP)

(73) Assignee: NEC Corporation, Minato-ku, Tokyo (JP)

(21) Appl. No.: 18/697,547

(22) PCT Filed: Oct. 15, 2021
(86) PCT No.: PCT/JP2021/038222

§ 371 Date: Apr. 1, 2024

(51) Int. Cl. B60W 30/14; B60W 60/00; G06Q 10/083

(52) U.S. Cl. CPC B60W 30/143; B60W 60/00256; G06Q 10/083; B60W 2554/4041

(57) ABSTRACT

In a delivery management apparatus, position information acquisition means acquires position information of a user vehicle and position information of a delivery vehicle. Speed adjustment information generation means generates speed adjustment information for bringing the user vehicle close to the delivery vehicle based on the position information of the user vehicle and the position information of the delivery vehicle. The speed adjustment information generation means transmits the generated speed adjustment information to the user vehicle and the delivery vehicle.

### TECHNICAL FIELD

The present disclosure relates to a delivery management system, a delivery management apparatus, a delivery management method, a user vehicle, a delivery vehicle, and a computer readable medium.

### BACKGROUND ART

As related art, Patent Literature 1 discloses an information management server that enables a person who has ordered a product to receive the product outside the person's home. In Patent Literature 1, a user vehicle in which a person who has ordered a product rides transmits current position thereof, route information, and vehicle speed information to the information management server. Further, a delivery vehicle that delivers the product transmits current position thereof, route information, and vehicle speed information to the information management server. The information management server compares the route information of the user vehicle with the route information of the delivery vehicle, and determines a place where the user vehicle and the delivery vehicle approach each other as a rendezvous point.

The information management server changes the route information of the user vehicle so that the user vehicle passes through the rendezvous point, and notifies the user vehicle about the changed route information. Further, the information management server changes the route information of the delivery vehicle so that the delivery vehicle passes through the rendezvous point, and notifies the delivery vehicle about the changed route information. Both the user vehicle and the delivery vehicle arrive at the rendezvous point. The person who has ordered a product can receive the product from the delivery vehicle at the rendezvous point.

As another related art, Patent Literature 2 discloses a product delivery system capable of delivering a product from a store to a traveling vehicle. The product delivery system disclosed in Patent Literature 2 includes a vehicle, a communication information terminal, and a plurality of stores. A person riding in the vehicle can operate the communication information terminal and order a product. Each of the plurality of stores operates an ordering website on the Internet accessible from the communication information terminal. Each of the plurality of stores can send a product using an unmanned aerial vehicle such as a drone.

The communication information terminal acquires, from a vehicle, a traveling route of the vehicle. The communication information terminal selects stores on or near the traveling route of the vehicle from among a plurality of stores. The communication information terminal displays the selected stores so as to be selectable as stores where a product can be ordered. The user selects one of the displayed stores and orders the product on the ordering website of the selected store. The store which has received the order suspends a product box including the product on an unmanned aerial vehicle, and makes the unmanned aerial vehicle fly toward the vehicle. In Patent Literature 2, a timing at which the delivery of the product is started, that is, a timing at which the unmanned aerial vehicle takes off, is determined based on the position of the store and the position of the vehicle. The unmanned aerial vehicle lands on the vehicle and delivers the product to the person riding in the vehicle.

### CITATION LIST

### Patent Literature

Patent Literature 1: Japanese Unexamined Patent Application Publication No. 2012-121700
Patent Literature 2: Japanese Unexamined Patent Application Publication No. 2019-144865

### SUMMARY OF INVENTION

### Technical Problem

In Patent Literature 1, the information management server cause the user vehicle and the delivery vehicle to move to the rendezvous point. The person who has ordered a product can receive the product at the rendezvous point. However, it is considered that the user vehicle and the delivery vehicle arrive at the rendezvous point at different times. In this case, one of the user vehicle and the delivery vehicle has to wait for the other to arrive at the rendezvous point.

In Patent Literature 2, a timing at which the unmanned aerial vehicle takes off is determined based on the position of the vehicle and the position of the store. In Patent Literature 2, when the store is a fixed store, it is possible to make the unmanned aerial vehicle take off at a timing when the vehicle passes through the vicinity of the store, and then deliver the product. However, when the store is a mobile store, in some cases the store and the vehicle cannot be brought close enough to each other since the position of the store is being moved. In this case, the store may not be able to deliver the product using the unmanned aerial vehicle.

The present disclosure has been made in view of the above circumstances and an object thereof is to provide a delivery management system, a delivery management apparatus, a delivery management method, and a computer readable medium by which a moving delivery vehicle can deliver a product or a service to a moving user vehicle.

It is also an object of the present disclosure to provide a delivery vehicle and a user vehicle used in the above delivery management system.

### Solution to Problem

In order to achieve the above objects, the present disclosure provides a delivery management apparatus as a first example aspect. The delivery management apparatus includes: position information acquisition means for acquiring position information of a user vehicle in which a user who purchases a product or is provided with a service rides, and position information of a delivery vehicle configured to deliver the product or the service to the user; and speed adjustment information generation means for generating speed adjustment information for bringing the user vehicle close to the delivery vehicle based on the position information of the user vehicle and the position information of the delivery vehicle, and transmitting the generated speed adjustment information to the user vehicle and the delivery vehicle.

The present disclosure provides a delivery management system as a second example aspect. The delivery management system includes: a user vehicle in which a user who purchases a product or is provided with a service rides; a delivery vehicle configured to deliver the product or the service to the user; and a delivery management apparatus connected to the user vehicle and the delivery vehicle. The delivery management apparatus includes: position information acquisition means for acquiring position information of the user vehicle and position information of the delivery vehicle; and speed adjustment information generation means for generating speed adjustment information for bringing the user vehicle close to the delivery vehicle based on the position information of the user vehicle and the position information of the delivery vehicle, and transmitting the generated speed adjustment information to the user vehicle and the delivery vehicle. The user vehicle includes: position information transmission means for transmitting position information to the delivery management apparatus; and speed adjustment instruction means for receiving the speed adjustment information and instructing the user vehicle to adjust a traveling speed of the user vehicle based on the received speed adjustment information. The delivery vehicle includes: position information transmission means for transmitting position information to the delivery management apparatus; and speed adjustment instruction means for receiving the speed adjustment information and instructing the delivery vehicle to adjust a traveling speed of the delivery vehicle based on the received speed adjustment information.

The present disclosure provides a delivery vehicle as a third example aspect. The delivery vehicle is a vehicle configured to deliver, to a user, a product purchased by the user or a service provided to the user. The delivery vehicle includes: position information transmission means for transmitting position information to a delivery management apparatus; and speed adjustment instruction means for receiving, from the delivery management apparatus, speed adjustment information for bringing a user vehicle in which the user who purchases the product or is provided with the service rides close to the delivery vehicle, and instructing the delivery vehicle to adjust a traveling speed of the delivery vehicle based on the received speed adjustment information.

The present disclosure provides a user vehicle as a fourth example aspect. The user vehicle is a vehicle in which a user who purchases a product or is provided with a service rides. The user vehicle includes: position information transmission means for transmitting position information to a delivery management apparatus; and speed adjustment instruction means for receiving, from the delivery management apparatus, speed adjustment information for bringing a delivery vehicle configured to deliver the product or the service to the user close to the user vehicle, and instructing the user vehicle to adjust a traveling speed of the user vehicle based on the received speed adjustment information.

The present disclosure provides a delivery management method as a fifth example aspect. The delivery management method includes: acquiring position information of a user vehicle in which a user who purchases a product or is provided with a service rides, and position information of a delivery vehicle configured to deliver the product or the service to the user; and generating speed adjustment information for bringing the user vehicle close to the delivery vehicle based on the position information of the user vehicle and the position information of the delivery vehicle, and transmitting the generated speed adjustment information to the user vehicle and the delivery vehicle.

The present disclosure provides a computer readable medium as a sixth example aspect. The computer readable medium stores a program for causing a computer apparatus to execute processing including: acquiring position information of a user vehicle in which a user who purchases a product or is provided with a service rides, and position information of a delivery vehicle configured to deliver the product or the service to the user; and generating speed adjustment information for bringing the user vehicle close to the delivery vehicle based on the position information of the user vehicle and the position information of the delivery vehicle, and transmitting the generated speed adjustment information to the user vehicle and the delivery vehicle.

### Advantageous Effects of Invention

The present disclosure provides a delivery management system, a delivery management apparatus, a delivery management method, a delivery vehicle, a user vehicle, and a computer readable medium by which a product or a service can be delivered from a moving delivery vehicle to a moving user vehicle.

### BRIEF DESCRIPTION OF DRAWINGS

FIG. 1 is a block diagram showing a schematic configuration of a delivery management system according to the present disclosure;

FIG. 2 is a block diagram showing a delivery management system according to an example embodiment of the present disclosure:

FIG. 3 is a block diagram showing an example of a configuration of a user vehicle;

FIG. 4 is a block diagram showing an example of a configuration of a delivery vehicle:

FIG. 5 is a block diagram showing an example of a configuration of a delivery management apparatus:

FIG. 6 is a flowchart showing an operation procedure in the delivery management apparatus:

FIG. 7 is a diagram schematically showing an example of delivery and receipt of a product using a drone:

FIG. 8 is a diagram schematically showing an example of delivery and receipt of a product using an extendable arm; and

FIG. 9 is a block diagram showing an example of a configuration of a computer apparatus.

### EXAMPLE EMBODIMENT

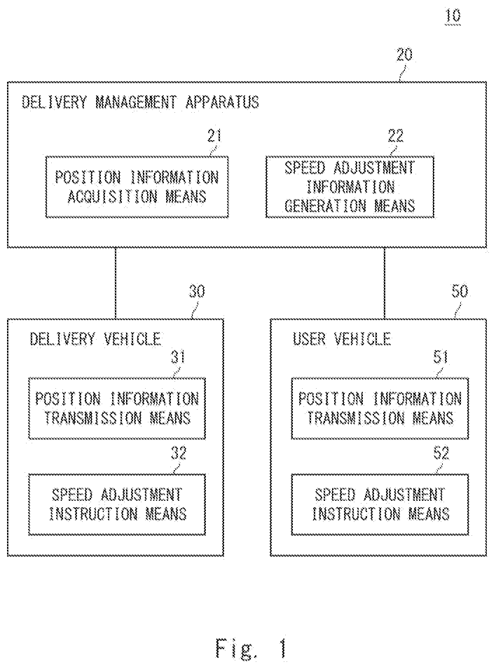

Prior to describing example embodiments of the present disclosure, an outline of the present disclosure will be described. FIG. 1 shows a schematic configuration of a delivery management system according to the present disclosure. A delivery management system 10 includes a delivery management apparatus 20, a delivery vehicle 30, and a user vehicle 50.

The user vehicle 50 is a vehicle in which a user who purchases a product or is provided with a service rides. The user vehicle 50 includes position information transmission means 51 and speed adjustment instruction means 52. The delivery vehicle 30 is a vehicle that delivers a product or a service to a user. The delivery vehicle 30 includes position information transmission means 31 and speed adjustment instruction means 32. The delivery management apparatus 20 is connected to the delivery vehicle 30 and the user vehicle 50. The delivery management apparatus 20 includes position information acquisition means 21 and speed adjustment information generation means 22.

The position information transmission means 51 of the user vehicle 50 transmits position information of the user vehicle 50 to the delivery management apparatus 20. The position information transmission means 31 of the delivery vehicle 30 transmits position information of the delivery vehicle 30 to the delivery management apparatus 20. In the delivery management apparatus 20, the position information acquisition means 21 acquires the position information of the user vehicle 50 and the position information of the delivery vehicle 30. The speed adjustment information generation means 22 generates speed adjustment information for bringing the user vehicle close to the delivery vehicle based on the acquired position information of the user vehicle and the acquired position information of the delivery vehicle. The speed adjustment information generation means 22 transmits the generated speed adjustment information to the user vehicle 50 and the delivery vehicle 30.

In the user vehicle 50, the speed adjustment instruction means 52 receives the speed adjustment information from the delivery management apparatus 20. The speed adjustment instruction means 52 instructs the user vehicle 50 to adjust a traveling speed thereof based on the received speed adjustment information. In the delivery vehicle 30, the speed adjustment instruction means 32 receives the speed adjustment information from the delivery management apparatus 20. The speed adjustment instruction means 32 instructs the delivery vehicle 30 to adjust a traveling speed thereof based on the received speed adjustment information.

In the present disclosure, the speed adjustment information generation means 22 generates speed adjustment information using the position information of the delivery vehicle 30 and the position information of the user vehicle 50. Both the traveling speed of the delivery vehicle 30 and the traveling speed the user vehicle 50 are adjusted in accordance with the speed adjustment information. In this way, it is possible to bring the moving delivery vehicle 30 close to the moving user vehicle 50 using the speed adjustment information. After the delivery vehicle 30 is brought close to the user vehicle 50, the delivery vehicle 30 can deliver a product or a service to the user vehicle. As described above, by the delivery management system 10 according to the present disclosure, it is possible to deliver a product or a service from the moving delivery vehicle 30 to the moving user vehicle 50.

The example embodiments according to the present disclosure will be described hereinafter in detail with reference to the drawings. Note that, for the clarification of the description, the following descriptions and the drawings are partially omitted and simplified as appropriate. Further, the same elements and similar elements are denoted by the same reference symbols throughout the drawings, and redundant descriptions are omitted as necessary.

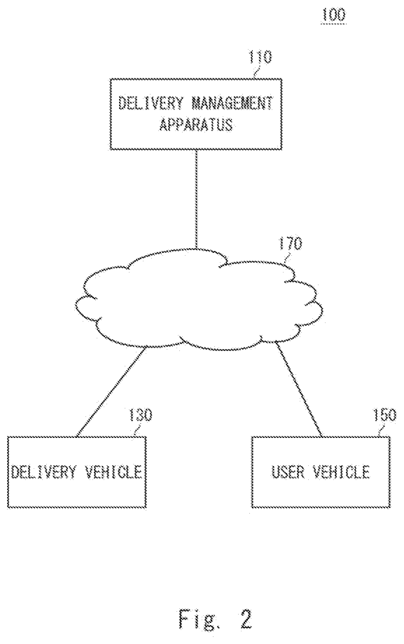

FIG. 2 shows a delivery management system according to an example embodiment of the present disclosure. A delivery management system 100 includes a delivery management apparatus 110, one or more delivery vehicles 130, and a user vehicle 150. In the delivery management system 100, the delivery management apparatus 110, the delivery vehicle 130, and the user vehicle 150 are connected to each other through a network 170. The network 170 includes, for example, a network using a communication line standard such as Long Term Evolution (LTE). The network 170 may include a wireless communication network such as WiFi (registered trademark) or a fifth generation mobile communication system. The delivery management system 100 corresponds to the delivery management system 10 shown in FIG. 1. The delivery management apparatus 110 corresponds to the delivery management apparatus 20 shown in FIG. 1.

The user vehicle 150 is a vehicle in which a user (a service user) using the delivery management system 100 rides. The user vehicle 150 may be, for example, a vehicle such as a passenger vehicle or a truck. Alternatively, the user vehicle 150 may be a vehicle in which a passenger rides, such as a bus, a taxi, or the like. The user may be a driver of the user vehicle 150, a fellow passenger, or a passenger. The user vehicle 150 may be a vehicle capable of autonomous driving or a vehicle driven by a person. In view of safety, when the user vehicle 150 is not an autonomously-driven vehicle, it is assumed that the user is a person other than the driver. The user vehicle 150 corresponds to the user vehicle 50 shown in FIG. 1.

The delivery vehicle 130 is a vehicle driven by a business operator or a store which provides a product to a user. The delivery vehicle 130 may be, for example, a vehicle such a mobile store, a kitchen car, or a delivery truck. The delivery vehicle 130 may be configured as being a vehicle that implements a mobile convenience store that sells articles such as food, beverages, and magazines. The delivery vehicle 130 delivers a product ordered by a user to the user. The delivery vehicle 130 may be a vehicle capable of autonomous driving or a vehicle driven by a person. A store staff member for picking up products may ride in the delivery vehicle 130. The delivery vehicle 130 corresponds to the delivery vehicle 30 shown in FIG. 1.

In this example embodiment, delivery and receipt of a product may be performed while the vehicle is traveling. For example, when the user vehicle 150 is traveling on an expressway, a user orders a product from the delivery vehicle 130 through the delivery management apparatus 110. The user receives the product delivered by the delivery vehicle 130, for example, on the expressway. When the user vehicle 150 is a vehicle capable of autonomous driving, a person riding in the user vehicle 150 may order a product and receive the product from the delivery vehicle 130. When the user vehicle 150 is a vehicle driven by a person, it is assumed that a person other than the driver receives the product.

In this example embodiment, a user has registered as a user in advance to receive a service. In the user registration, the user registers vehicle information of the user vehicle 150 in the delivery management apparatus 110. The vehicle information includes, for example, the type and the number of the user vehicle 150. Further, in the user registration, the user registers payment information in the delivery management apparatus 110. At least one of the vehicle information and the payment information may not necessarily be registered in advance in the delivery management apparatus 110. For example, the user may transmit at least one of the vehicle information and the payment information to the delivery management apparatus 110 when the user orders a product.

Meanwhile, a service provider has registered as a user in advance to provide a service. In the user registration, the service provider registers, for example, a service content (a type of business) and vehicle information of the delivery vehicle 130 in the delivery management apparatus 110. The vehicle information includes, for example, the type and the number of the delivery vehicle 130. When a traveling route of the delivery vehicle is determined, the service provider registers information about the traveling route in the delivery management apparatus 110. For example, when the delivery vehicle 130 circulates along a predetermined route, the service provider registers the circulating route of the delivery vehicle 130 in the delivery management apparatus 110.

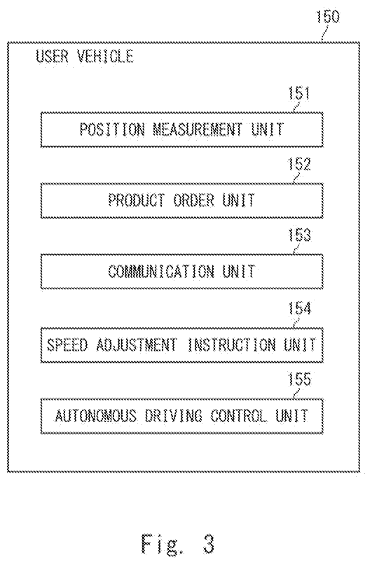

FIG. 3 shows an example of a configuration of the user vehicle 150. The user vehicle 150 includes a position measurement unit 151, a product order unit 152, a communication unit 153, a speed adjustment instruction unit 154, and an autonomous driving control unit 155. The communication unit 153 is a communication unit that performs wireless communication with the network 170 (see FIG. 2). The communication unit 153 includes a wireless communication antenna, a transmitter, and a receiver. The position measurement unit 151 measures a position of the user vehicle 150. The position measurement unit 151 acquires position information of the user vehicle 150 using, for example, Global Navigation Satellite System (GNSS). The position measurement unit 151 transmits the acquired position information to the delivery management apparatus 110 through the communication unit 153. The position measurement unit 151 corresponds to the position information transmission means 51 shown in FIG. 1.

The autonomous driving control unit (autonomous driving control means) 155 controls autonomous driving of the user vehicle 150. The autonomous driving control unit 155 is configured as, for example, an Electric Control Unit (ECU). The ECU includes, for example, one or more processors, one or more memories, and peripheral devices such as a communication module. The autonomous driving control unit 155 is connected, for example, to a vehicle control ECU that controls traveling of the user vehicle 150 through an in-vehicle Local Area Network (LAN), a Controller Area Network (CAN), or the like. The autonomous driving control unit 155, for example, acquires sensor information from a peripheral monitoring sensor (not shown) and a vehicle sensor, and controls the user vehicle 150 to autonomously drive based on the acquired sensor information.

The speed adjustment instruction unit 154 receives speed adjustment information from the delivery management apparatus 110 through the communication unit 153. The speed adjustment instruction unit 154 instructs the autonomous driving control unit 155 to adjust the traveling speed of the user vehicle 150 based on the received speed adjustment information. The speed adjustment instruction unit 154 corresponds to the speed adjustment instruction means 52 shown in FIG. 1.

The product order unit 152 is used to order a product from the delivery management apparatus 110. The product order unit 152, for example, transmits request information to the delivery management apparatus 110 through the communication unit 153. The request information includes, for example, vehicle information of the user vehicle 150, position information acquired by the position measurement unit 151, and information specifying a product desired by a user. The information specifying a product includes, for example, the type of the product. The request information may include the traveling speed of the user vehicle 150, the destination, and the desired delivery time.

After the product order unit 152 transmits the request information, the product order unit 152 receives a list of delivery vehicles that can deliver the product to the user vehicle 150 from the delivery management apparatus 110 through the communication unit 153. The product order unit 152 presents the list of delivery vehicles to the user. The user can select the delivery vehicle 130 from the list and order a product which the selected delivery vehicle 130 can deliver. The product order unit 152 transmits information about the product ordered by the user to the delivery management apparatus 110 through the communication unit 153. The function of the product order unit 152 may be implemented by an on-board Human Machine Interface (HMI) such as a car navigation apparatus. Alternatively, the function of the product order unit 152 may be implemented by a communication terminal device such as a smartphone or a tablet terminal possessed by a user.

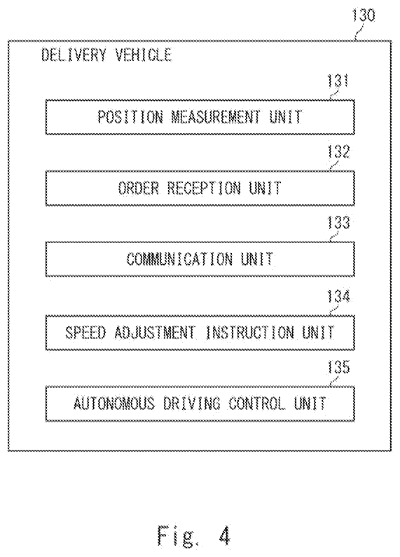

FIG. 4 shows an example of a configuration of the delivery vehicle 130. The delivery vehicle 130 includes a position measurement unit 131, an order reception unit 132, a communication unit 133, a speed adjustment instruction unit 134, and an autonomous driving control unit 135. The communication unit 133 performs wireless communication with the network 170 (see FIG. 2). The communication unit 133 includes a wireless communication antenna, a transmitter, and a receiver. The position measurement unit 131 measures a position of the delivery vehicle 130. The position measurement unit 131 acquires position information of the delivery vehicle 130 using, for example, GNSS. The position measurement unit 131 transmits the acquired position information to the delivery management apparatus 110 through the communication unit 133. The position measurement unit 131 corresponds to the position information transmission means 31 shown in FIG. 1.

The autonomous driving control unit (autonomous driving control means) 135 controls autonomous driving of the delivery vehicle 130. The autonomous driving control unit 135, for example, is configured as being an electronic control unit (ECU). The autonomous driving control unit 135 is connected, for example, to a vehicle control ECU that controls traveling of the delivery vehicle 130 through an in-vehicle LAN or a CAN. The autonomous driving control unit 135, for example, acquires sensor information from a peripheral monitoring sensor (not shown) and a vehicle sensor, and controls the delivery vehicle 130 to autonomously drive based on the acquired sensor information. For example, the autonomous driving control unit 135 controls the delivery vehicle 130 to autonomously drive so that it circulates along a predetermined circulating route.

The speed adjustment instruction unit 134 receives speed adjustment information from the delivery management apparatus 110 through the communication unit 133. The speed adjustment instruction unit 134 instructs the autonomous driving control unit 135 to adjust a traveling speed of the delivery vehicle 130 based on the received speed adjustment information. The speed adjustment instruction unit 134 corresponds to the speed adjustment instruction means 32 shown in FIG. 1.

The order reception unit 132 receives an order from a user through the delivery management apparatus 110. The order reception unit 132 receives order information from the delivery management apparatus 110 through the communication unit 133. The order information includes, for example, a product which the user wants to purchase, the number of the products, a method for receiving the product, and vehicle information of the user vehicle 150. A person riding in the delivery vehicle 130 checks the order information and inputs information as to whether or not the order can be handled. The order reception unit 132 sends a response as to whether or not the order can be handled to the delivery management apparatus 110. The order reception unit 132 may automatically check stock information and automatically send a response as to whether or not the order can be handled. The function of the order reception unit 132 may be implemented by an on-board HMI or by a communication terminal device such as a smartphone or a tablet terminal possessed by a person riding in the delivery vehicle 130.

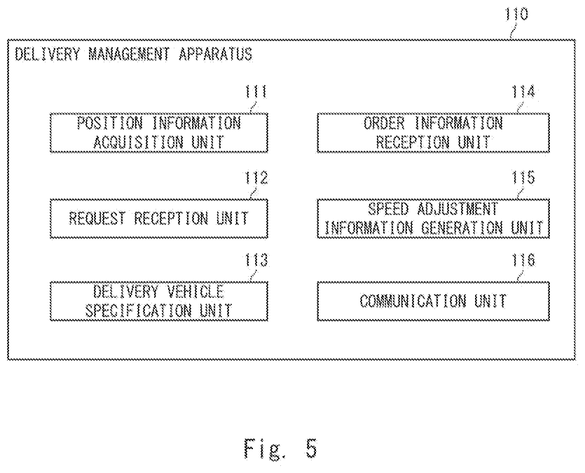

FIG. 5 shows an example of a configuration of the delivery management apparatus 110. The delivery management apparatus 110 includes a position information acquisition unit 111, a request reception unit 112, a delivery vehicle specification unit 113, an order information reception unit 114, a speed adjustment information generation unit 115, and a communication unit 116. The delivery management apparatus 110, for example, is configured as being a server apparatus including one or more processors and one or more memories. At least some of the functions of the respective units included in the delivery management apparatus 110 are implemented by the processor operating in accordance with a program loaded from the memory.

The communication unit 116 communicates with the delivery vehicle 130 and the user vehicle 150 through the network 170 (see FIG. 2). The position information acquisition unit 111 acquires position information from the delivery vehicle 130 through the communication unit 116. The position information acquisition unit 111 also acquires position information from the user vehicle 150 through the communication unit 116. The position information acquisition unit 111 acquires position information of the delivery vehicle 130 periodically, for example, at predetermined time intervals. The position information acquisition unit 111 periodically acquires position information of the user vehicle 150, for example, until the delivery of a product is completed after request information is transmitted from the user vehicle 150. The position information acquisition unit 111 corresponds to the position information acquisition means 21 shown in FIG. 1.

The request reception unit (request reception means) 112 receives request information from the user vehicle 150 through the communication unit 116. The delivery vehicle specification unit (delivery vehicle specification means) 113 specifies the delivery vehicle 130 that can deliver a product desired by a user to the user vehicle 150 based on the received request information. The delivery vehicle specification unit 113 specifies, for example, a delivery vehicle that handles the product desired by the user and is not delivering a product to another user as the delivery vehicle that can deliver the product to the user.

The delivery vehicle specification unit 113 may specify the delivery vehicle 130 that can deliver the product to the user vehicle 150 based on position information of the user vehicle 150 and position information of the delivery vehicle 130. For example, the delivery vehicle specification unit 113 may specify a delivery vehicle traveling in an area within a predetermined distance from the user vehicle as the delivery vehicle that can deliver the product to the user. The delivery vehicle specification unit 113 may specify a delivery vehicle that is close to the user vehicle and traveling in the same direction as the user vehicle on an expressway as the delivery vehicle that can deliver the product to the user. When the delivery vehicle 130 is circulating along a circulating route, the delivery vehicle specification unit 113 may specify the delivery vehicle that can deliver the product to the user based on the destination of the user vehicle 150 and the circulating route of the delivery vehicle 130.

The delivery vehicle specification unit 113 estimates an approximate time required to deliver a product to a user for each of the specified delivery vehicles. The delivery vehicle specification unit 113 estimates a time required to deliver a product to a user based on, for example, position information of the delivery vehicle 130, position information of the user vehicle 150, the legal speed on an expressway, and a condition of the road (the degree of congestion) between the delivery vehicle 130 and the user vehicle 150. When a user specifies a desired delivery time, the delivery vehicle specification unit 113 may specify a delivery vehicle that can deliver a product to the user within the desired time. In addition to the approximate time required to deliver a product to a user, the delivery vehicle specification unit 113 may estimate an approximate place (section) where a product can be delivered to the user.

The delivery vehicle specification unit 113 transmits, through the communication unit 116, a list of the specified delivery vehicles to the user vehicle 150 that has transmitted the request information. The list of the delivery vehicles includes, for example, store names and information about the appearances of the delivery vehicles. The list of the delivery vehicles also includes product information such as product names, prices, and the number of products in stock. The list of the delivery vehicles may include scheduled delivery times and scheduled delivery points. The scheduled delivery time may be calculated based on an estimated time required for delivery. The list of the delivery vehicles may include methods for receiving a product which a user can use when the user receives a product from the delivery vehicle 130. Examples of the methods for receiving a product may include, for example, delivery and receipt using a drone, delivery and receipt using an extendable arm, and delivery and receipt using an extendable tray.

A user refers to the list of the delivery vehicles in the user vehicle 150. The user determines, from among the delivery vehicles included in the list, a delivery vehicle (a mobile store) where the user purchases a product, and specifies a product to be purchased. Further, the user selects a desired delivery and receipt method (i.e., a desired method for delivering and receiving a product) from among available delivery and receipt methods. The product order unit 152 (see FIG. 3) of the user vehicle 150 transmits order information about the order of the product to the delivery management apparatus 110 through the communication unit 153. The order information includes the product to be purchased, the number of the products to be purchased, and the selected delivery and receipt method.

In the delivery management apparatus 110, the order information reception unit (order information reception means) 114 receives the order information from the user vehicle 150 through the communication unit 116. The order information reception unit 114 transmits the received order information to the delivery vehicle 130, which is the order destination, through the communication unit 116. As described above, the order reception unit 132 (see FIG. 4) of the delivery vehicle 130 receives the order information from the delivery management apparatus 110 through the communication unit 133. A person riding in the delivery vehicle 130 checks the order information and inputs whether or not the order can be handled. The order reception unit 132 sends a response as to whether or not the order can be handled to the delivery management apparatus 110.

In the delivery management apparatus 110, the speed adjustment information generation unit 115 generates speed adjustment information for bringing the delivery vehicle 130 close to the user vehicle 150 when a response indicating that the order can be handled is received from the delivery vehicle 130. The speed adjustment information generation unit 115 transmits the generated speed adjustment information to at least one of the delivery vehicle 130 and the user vehicle 150 through the communication unit 116. When a response indicating that the order cannot be handled is received from the delivery vehicle 130, the delivery vehicle specification unit 113 transmits a list of the delivery vehicles to the user vehicle 150 through the communication unit 116 in addition to a message to the effect that the order cannot be handled.

In this example embodiment, the speed adjustment information generation unit 115 generates first speed adjustment information transmitted to the delivery vehicle 130 and second speed adjustment information transmitted to the user vehicle 150. The speed adjustment information generation unit 115 generates the first speed adjustment information and the second speed adjustment information based on position information and a traveling speed of the delivery vehicle 130 and position information and a traveling speed of the user vehicle 150. The speed adjustment information generation unit 115 transmits the first speed adjustment information to the delivery vehicle 130 and transmits the second speed adjustment information to the user vehicle through the communication unit 116. The speed adjustment information generation unit 115 corresponds to the speed adjustment information generation means 22 shown in FIG. 1.

The delivery vehicle 130 receives the first speed adjustment information from the delivery management apparatus 110. The first speed adjustment information includes information specifying a traveling speed of the delivery vehicle 130. In the delivery vehicle 130, the speed adjustment instruction unit 134 inputs the first speed adjustment information to the autonomous driving control unit 135. The autonomous driving control unit 135 adjusts a traveling speed of the delivery vehicle 130 based on the first speed adjustment information. The autonomous driving control unit 135, for example, increases or decreases the traveling speed of the delivery vehicle 130 so that the delivery vehicle 130 travels at the traveling speed indicated by the first speed adjustment information.

The user vehicle 150 receives the second speed adjustment information from the delivery management apparatus 110. The second speed adjustment information includes information specifying a traveling speed of the user vehicle 150. In the user vehicle 150, the speed adjustment instruction unit 154 inputs the second speed adjustment information to the autonomous driving control unit 155. The autonomous driving control unit 155 adjusts the traveling speed of the user vehicle 150 based on the second speed adjustment information. The autonomous driving control unit 155, for example, increases or decreases the traveling speed of the user vehicle 150 so that the user vehicle 150 travels at the traveling speed indicated by the second speed adjustment information.

An example of a case in which speed adjustment information is generated will be described. When the delivery vehicle 130 is traveling ahead of the user vehicle 150, the traveling speed of the delivery vehicle 130 may be relatively reduced and the traveling speed of the user vehicle 150 may be relatively increased in order to bring the delivery vehicle 130 close to the user vehicle 150. The speed adjustment information generation unit 115 generates first speed adjustment information for reducing the traveling speed of the delivery vehicle 130 by a predetermined amount. The speed adjustment information generation unit 115 also generates second speed adjustment information for making the traveling speed of the user vehicle 150 higher than the traveling speed of the delivery vehicle 130. The speed adjustment information generation unit 115 may generate second speed adjustment information when the traveling speed of the user vehicle 150 is low and thus the user vehicle 150 cannot catch up with the delivery vehicle 130.

The delivery vehicle 130 receives the first speed adjustment information and the user vehicle 150 receives the second speed adjustment information. The delivery vehicle 130 travels at a speed which is equal to or lower than the traveling speed of the user vehicle 150 in accordance with the first speed adjustment information while maintaining the minimum speed limit of the expressway. Further, the user vehicle 150 travels at a speed which is higher than the traveling speed of the delivery vehicle 130 in accordance with the second speed adjustment information while maintaining the speed limit of the expressway. Since the traveling speed of the user vehicle 150 is higher than the traveling speed of the delivery vehicle 130, the user vehicle 150 can reduce the distance between it and the delivery vehicle 130 so as to catch up with the delivery vehicle 130.

Contrary to the above, when the delivery vehicle 130 is traveling behind the user vehicle 150, the traveling speed of the delivery vehicle 130 may be relatively increased and the traveling speed of the user vehicle 150 may be relatively reduced in order to bring the delivery vehicle 130 close to the user vehicle 150. In this case, the speed adjustment information generation unit 115 generates second speed adjustment information for reducing the traveling speed of the user vehicle 150 by a predetermined amount. The speed adjustment information generation unit 115 also generates first speed adjustment information for making the traveling speed of the delivery vehicle 130 higher than the traveling speed of the user vehicle 150. The speed adjustment information generation unit 115 may generate second speed adjustment information when the traveling speed of the user vehicle 150 is high and thus the delivery vehicle 130 cannot catch up with the user vehicle 150.

The delivery vehicle 130 receives the first speed adjustment information and the user vehicle 150 receives the second speed adjustment information. The delivery vehicle 130 travels at a speed which is higher than the traveling speed of the user vehicle 150 in accordance with the first speed adjustment information while maintaining the speed limit of the expressway. Further, the user vehicle 150 travels at a speed which is equal to or lower than the traveling speed of the delivery vehicle 130 in accordance with the second speed adjustment information while maintaining the minimum speed limit of the expressway. Since the traveling speed of the delivery vehicle 130 is higher than the traveling speed of the user vehicle 150, the delivery vehicle 130 can reduce the distance between it and the user vehicle 150 so as to catch up with the user vehicle 150.

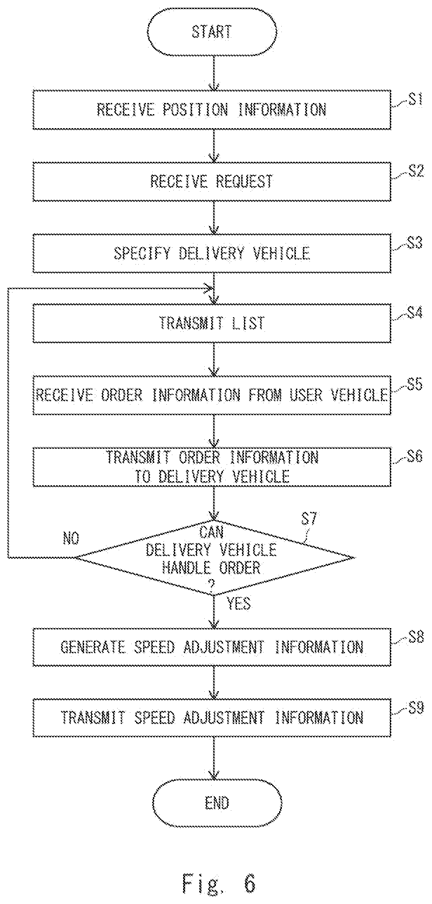

Next, an operation procedure will be described. FIG. 6 shows an operation procedure (a delivery management method) in the delivery management apparatus 110. In the delivery management apparatus 110, the position information acquisition unit 111 receives position information from the delivery vehicle 130 (Step S1). For example, the position information acquisition unit 111 continuously receives position information from the delivery vehicle 130, and acquires the latest position information of the delivery vehicle 130. When a user orders a product, the request reception unit 112 receives request information from the user vehicle 150 through the communication unit 116 (Step S2). For example, after the request information is received in Step S2, the position information acquisition unit 111 starts to acquire position information of the user vehicle 150. The delivery vehicle specification unit 113 specifies one or more delivery vehicles 130 that can deliver a product desired by the user to the user vehicle 150 (Step S3). In Step S3, the delivery vehicle specification unit 113 specifies, for example, the delivery vehicle 130 traveling near the user vehicle 150 and handling the product desired by the user as the delivery vehicle that can deliver the product to the user vehicle 150.

The delivery vehicle specification unit 113 transmits a list of the one or more delivery vehicles 130 specified in Step S3 to the user vehicle 150 through the communication unit 116 (Step S4). The list may include methods for delivering and receiving a product available at the time of delivery and receipt of the product in each of the delivery vehicle 130. The user selects the delivery vehicle 130 and a product to be purchased by referring to the list received from the delivery management apparatus 110. When the user selects the product and the delivery vehicle 130, the product order unit 152 (see FIG. 3) of the user vehicle 150 transmits order information to the delivery management apparatus 110 through the communication unit 153.

In the delivery management apparatus 110, the order information reception unit 114 receives the order information from the user vehicle 150 through the communication unit 116 (Step S5). The order information may include a method for delivering and receiving the product used at the time of delivery and receipt of the product. The order information reception unit 114 transfers, through the communication unit 116, the order information to the delivery vehicle 130 selected by the user (Step S6). In the delivery vehicle 130, the order reception unit 132 (see FIG. 4) receives the order information, and presents the order information to a person riding in the delivery vehicle 130 who is a store staff member of the mobile store. The store staff member inputs information as to whether or not the order can be handled to the order reception unit 132. The order reception unit 132 sends a response as to whether or not the order can be handled to the delivery management apparatus 110.

In the delivery management apparatus 110, the order information reception unit 114 receives the response as to whether or not the order can be handled from the delivery vehicle 130 through the communication unit 116. The order information reception unit 114 determines whether or not the delivery vehicle 130 can handle the order (Step S7). When it is determined in Step S7 that the delivery vehicle 130 cannot handle the order, processing returns to Step S4, and the delivery vehicle specification unit 113 retransmits the list of the delivery vehicles 130 to the user vehicle 150 through the communication unit 116. When the delivery vehicle 130 cannot handle the order, the delivery management apparatus 110 may make the user vehicle 150 retransmit request information. When it is determined in Step S7 that the delivery vehicle 130 can handle the order, the speed adjustment information generation unit 115 generates speed adjustment information (Step S8). In Step S8, the speed adjustment information generation unit 115 generates first speed adjustment information to be transmitted to the delivery vehicle 130 and second speed adjustment information to be transmitted to the user vehicle 150. The speed adjustment information generation unit 115 transmits the speed adjustment information to the delivery vehicle 130 and the user vehicle 150 through the communication unit 116 (Step S9). In Step S9, the speed adjustment information generation unit 115 transmits the first speed adjustment information to the delivery vehicle 130 and transmits the second speed adjustment information to the user vehicle 150.

The delivery vehicle 130 and the user vehicle 150 each travel at a traveling speed corresponding to the received speed adjustment information. The distance between the delivery vehicle 130 and the user vehicle 150 is reduced by traveling the delivery vehicle 130 and the user vehicle 150 each at a speed corresponding to the speed adjustment information. After the delivery vehicle 130 and the user vehicle 150 are brought close enough to each other, the delivery vehicle 130 and the user vehicle 150 communicate with each other and keep their relative position constant. After that, the product is delivered from the delivery vehicle 130 to the user vehicle 150.

The delivery and receipt of a product is carried out, for example, as described below. When the distance between the delivery vehicle 130 and the user vehicle 150 is within a predetermined distance, for example, within 100 m, the delivery management apparatus 110 transmits a message instructing the user vehicle 150 to change the lane it is traveling in to the left lane (the driving lane) through the communication unit 116. The user vehicle 150 receives the message and then changes the lane it is traveling in to the left lane. When the user vehicle 150 is traveling in the left lane, it continues to travel in the left lane.

The delivery vehicle 130 travels behind the user vehicle 150. The delivery vehicle 130 captures an image of the license plate of the vehicle ahead of it using a front camera to specify the user vehicle 150. When the user vehicle 150 can be specified, the delivery vehicle 130 does not necessarily need to travel immediately behind the user vehicle 150, and other vehicles may be present between the delivery vehicle 130 and the user vehicle 150. After the delivery vehicle 130 specifies the user vehicle 150, the delivery vehicle 130 performs platooning in cooperation with the user vehicle 150. After the delivery vehicle 130 specifies the user vehicle 150, the delivery vehicle 130 delivers the product to the user by the delivery and receipt method selected by the user.

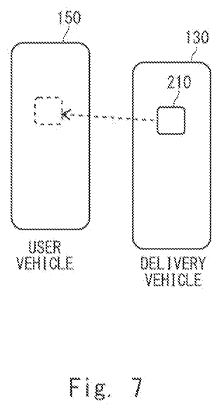

FIG. 7 schematically shows an example of delivery and receipt of a product using a drone. In this example, the delivery vehicle 130 travels on the right side of the user vehicle 150 at a traveling speed substantially equal to the traveling speed of the user vehicle 150. A person riding in the delivery vehicle 130 loads a product onto a drone 210. The drone 210 takes off from the delivery vehicle 130 and lands on the user vehicle 150. A user receives the product from the drone 210. The user pays for the product by a predetermined payment method indicated in payment information registered in the delivery management apparatus 110. The user may pay for the product by using a payment apparatus such as a card reading apparatus mounted on the drone 210.

Note that, although an example of a case in which the delivery vehicle 130 travels on the right side of the user vehicle 150 has been described above, this example embodiment is not particularly limited thereto. The delivery vehicle 130 may travel on the left side of the user vehicle 150. Alternatively, the delivery vehicle 130 may travel in front of or behind the user vehicle 150. The delivery vehicle 130 may be within a certain distance of the user vehicle 150, and the positional relationship between the delivery vehicle 130 and the user vehicle 150 is not limited to the particular positional relationship described above. The delivery and receipt of a product using the drone 210 is useful when the delivery vehicle 130 and the user vehicle 150 cannot travel side by side due to traffic congestion or the like.

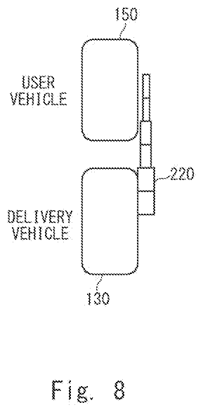

FIG. 8 schematically shows an example of delivery and receipt of a product using an extendable arm. In this example, the delivery vehicle 130 travels directly behind the user vehicle 150 at the same speed as the traveling speed of the user vehicle 150. The delivery vehicle 130 may travel immediately in front of the user vehicle 150 or on the left or right side of the user vehicle 150. A person riding in the delivery vehicle 130 attaches a product to the tip of an extendable arm 220 and extends the extendable arm 220 toward the user vehicle 150 which is performing platooning. A user can receive the product from the extendable arm 220. An extendable tray may be used instead of the extendable arm 220. In this case, the delivery vehicle 130 may travel on the right or left side of the user vehicle 150.

In this example embodiment, in the delivery management apparatus 110, the speed adjustment information generation unit 115 generates speed adjustment information in accordance with information such as a positional relationship between the delivery vehicle 130 and the user vehicle 150. The speed adjustment information generation unit 115 transmits the generated speed adjustment information to the delivery vehicle 130 and the user vehicle 150. In the delivery vehicle 130, the autonomous driving control unit 135 controls the delivery vehicle 130 to travel at a speed corresponding to the received speed adjustment information. Further, in the user vehicle 150, the autonomous driving control unit 155 controls the user vehicle 150 to travel at a speed corresponding to the received speed adjustment information. The delivery vehicle 130 and the user vehicle each travel at a speed corresponding to the speed adjustment information, whereby the delivery vehicle 130 and the user vehicle 150 can be brought close to each other.

It is considered that, in the future, fully autonomous driving on expressways will be realized and thus the burden on drivers will be reduced, and as a result, use of service areas for rest breaks will be reduced. Further, it is considered that, regarding vehicles for distribution of goods and buses, drivers will be required to reduce rest periods and reach their destinations faster. In a case in which fully autonomous driving is realized, it is expected that even when a driver or a person riding in the vehicle wants to buy items, such as food and drinks or magazines, for the driver or the person to spend a comfortable time inside a moving vehicle, the driver will not take the trouble to park the vehicle to buy such items. Further, it is expected that, in a shared bus, such as a sightseeing bus, a passenger will not want the driver to park the bus for the passenger's own convenience.

In this example embodiment, a user who rides in the user vehicle 150 can order a product from the delivery vehicle 130 traveling nearby while the user vehicle 150 is moving. The user can receive the product which the user has ordered from the delivery vehicle 130. Therefore, the user does not have to stop at a service area to purchase a product. In this example embodiment, the user can receive a product while continuing to move. Therefore, the user can spend a comfortable time inside the vehicle while reducing the required time to reach the destination. On the other hand, a seller can deliver a product from the delivery vehicle 130 to the traveling user vehicle 150. Therefore, the seller can increase the number of opportunities for selling a product. This would compensate for the decrease in opportunities for selling the product caused by the decrease in the number of users in a service area.

Note that, in the above example embodiment, an example of a case in which a product is delivered to and received by a user while the user vehicle 150 is traveling has been described. However, the present disclosure is not limited thereto. For example, when the user vehicle 150 is not an autonomously-driven vehicle and only a driver is riding in the user vehicle 150, delivery and receipt of a product may be performed while the user vehicle 150 is stopped. In this case, for example, the delivery management apparatus 110 designates a place on an expressway where a vehicle is permitted to stop (e.g., a road shoulder) as a meeting point where the delivery vehicle 130 will meet the user vehicle 150. The driver of the user vehicle 150 drives the user vehicle 150 to the specified meeting point and stops the user vehicle 150. After that, the driver of the user vehicle 150 can receive a product from the delivery vehicle 130 at the meeting point using one of the above-described methods for delivering and receiving a product.

In the above example embodiment, an example of a case in which a product is delivered from the delivery vehicle 130, which is a mobile store, to the user vehicle 150 has been described. However, the present disclosure is not limited thereto. A product may be delivered not only from a mobile store that circulates along a predetermined route but also from a store located at a point along an expressway or located in a service area. In this case, as a method for delivering and receiving the product, a method using a drone may be used.

In the above case, when request information is received from the user vehicle 150, the delivery management apparatus 110 specifies a store in the vicinity of a route where the user vehicle 150 is scheduled to travel in addition to the delivery vehicle 130 or instead of the delivery vehicle 130. The delivery management apparatus 110 notifies the user vehicle 150 about the store in the vicinity of the route. As a delivery and receipt method that can be used to deliver a product from the store in the vicinity of the route to the user vehicle 150, delivery of a product using a drone and delivery and receipt of a product on the road shoulder may be used.

The store in the vicinity of the route determines a meeting point when the order is confirmed. The meeting point may be determined by the delivery management apparatus 110. When there are a plurality of persons who have ordered products, different meeting points may be determined for each of the persons (the user vehicles) in order to correctly deliver the product to each of the user vehicles 150. For example, the delivery management apparatus 110 may determine, for each user vehicle 150, a point that is at least one kilometer away from each other as a meeting point. The store (a store apparatus) in the vicinity of the route transmits a message to the user vehicle 150 when the drone arrives at the meeting point or when a store staff member arrives at the road shoulder which is the meeting point. The user vehicle 150 transmits a message to the store apparatus when it approaches the meeting point. By exchanging messages between the user vehicle 150 and the store apparatus, the user can receive the product at the meeting point.

Note that, when a product is delivered by a drone, a product ordered by another user may be delivered to a user by mistake. In order to avoid such confusion, a store may place a product in bags of different colors for each user, and notify the user in advance about the color of the bag in which the product is placed. By looking at the color of the bag containing the product carried by the drone, the user can know that the product is the product which the user has ordered.

In the above example embodiment, a description has been given with a focus on an example of a case in which the delivery vehicle 130 and the user vehicle 150 are autonomously-driven vehicles. However, the present disclosure is not limited thereto. In the present disclosure, either one or both of the delivery vehicle 130 and the user vehicle 150 may be vehicles driven by a person riding in the vehicle. Alternatively, either one or both of the delivery vehicle 130 and the user vehicle 150 may be vehicles driven remotely by a remote driver.

For example, when the delivery vehicle 130 is a vehicle driven by a person riding in the vehicle, the speed adjustment instruction unit 134 of the delivery vehicle 130 may have a driver adjust the traveling speed of the delivery vehicle 130 by displaying a message instructing the driver to increase the traveling speed of the delivery vehicle 130 or a message instructing the driver to reduce the traveling speed of the delivery vehicle 130. When the user vehicle 150 is a vehicle driven by a person riding in the vehicle, the speed adjustment instruction unit 154 of the user vehicle 150 may have a driver adjust the traveling speed of the user vehicle 150 by displaying a message instructing the driver to increase the traveling speed of the user vehicle 150 or a message instructing the driver to reduce the traveling speed of the user vehicle 150.

In the above example embodiment, an example of a case in which a user purchases a product from a mobile store (a delivery vehicle) has been described. However, the present disclosure is not limited thereto. In the present disclosure, a user may order provision of a service from the delivery vehicle 130. The services that can be provided by the delivery vehicle 130 may include provision of a toilet in the delivery vehicle, collection of garbage, and provision of food and drinks in the delivery vehicle. For example, the delivery vehicle 130 travels side by side with the user vehicle 150 and extends an accessway to the user vehicle 150. A user can move to the delivery vehicle 130 while the user vehicle 150 is traveling and use the toilet in the delivery vehicle. Alternatively, the user can purchase food and drinks in the delivery vehicle 130 and eat and drink them there. When the service provided by the delivery vehicle 130 is collection of garbage, the user may move to the delivery vehicle 130 and put garbage in a garbage bin in the delivery vehicle 130. Alternatively, the delivery vehicle 130 may collect garbage from the user vehicle 150 using means for receiving the garbage, such as a drone, an extendable arm, or an extendable tray.

In the above example embodiment, an example of a case in which the delivery vehicle 130 and the user vehicle 150 travel on an expressway has been described. However, the present disclosure is not limited thereto. The road on which the delivery vehicles 130 and the user vehicles 150 travel is not limited to an expressway. For example, the present disclosure may also apply to a case in which the delivery vehicle 130 and the user vehicle 150 travel on a general road or an exclusive car road other than an expressway.

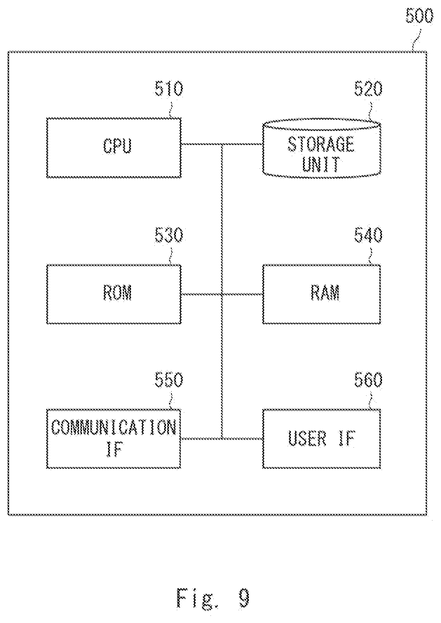

In the present disclosure, the delivery management apparatus 110 may be configured as being a computer apparatus (a server apparatus). FIG. 9 shows an example of a configuration of a computer apparatus that may be used as the delivery management apparatus 110. A computer apparatus 500 includes a Central Processing Unit (CPU) 510, a storage unit 520, a Read Only Memory (ROM) 530, a Random Access Memory (RAM) 540, a communication interface (IF) 550, and a user interface 560.

The communication interface 550 is an interface for connecting the computer apparatus 500 to a communication network through wired communication means, wireless communication means, or the like. The user interface 560 includes, for example, a display unit such as a display. The user interface 560 also includes an input unit such as a keyboard, a mouse, and a touch panel.

The storage unit 520 is an auxiliary storage device capable of holding various types of data. The storage unit 520 does not necessarily have to be a part of the computer apparatus 500. The storage unit 520 may be an external storage device or a cloud storage connected to the computer apparatus 500 through a network.

The ROM 530 is a non-volatile storage device. For example, a semiconductor storage device such as a flash memory having a relatively small capacity is used for the ROM 530. A program executed by the CPU 510 may be stored in the storage unit 520 or the ROM 530. The storage unit 520 or the ROM 530 stores, for example, various types of programs for implementing the functions of the respective units in the delivery management apparatus 110.

The program includes instructions (or software codes) that, when loaded into a computer, cause the computer to perform one or more of the functions described in the example embodiments. The program may be stored in a non-transitory computer readable medium or a tangible storage medium. By way of example, and not a limitation, non-transitory computer readable media or tangible storage media can include a RAM, a ROM, a flash memory, a solid-state drive (SSD) or other types of memory technologies, a compact disc (CD), a digital versatile disc (DVD), a Blu-ray (Registered Trademark) disc or other types of optical disc storage, a magnetic cassette, a magnetic tape, and a magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The RAM 540 is a volatile storage device. Various types of semiconductor memory devices such as a Dynamic Random Access Memory (DRAM) or a Static Random Access Memory (SRAM) are used for the RAM 540. The RAM 540 may be used as an internal buffer that temporarily stores data and the like. The CPU 510 loads the program stored in the storage unit 520 or the ROM 530 in the RAM 540 and executes the loaded program. The CPU 510 executes the program, whereby the functions of the respective units in the delivery management apparatus 110 may be implemented. The CPU 510 may include an internal buffer that can temporarily store data and the like.

Although the example embodiments according to the present disclosure have been described above in detail, the present disclosure is not limited to the above-described example embodiments, and the present disclosure also includes those that are obtained by making changes or modifications to the above-described example embodiments without departing from the scope and spirit of the present disclosure.

For example, the whole or part of the example embodiments disclosed above can be described as, but not limited to, the following supplementary notes.

### Supplementary Note 1

A delivery management apparatus including:
position information acquisition means for acquiring position information of a user vehicle in which a user who purchases a product or is provided with a service rides, and position information of a delivery vehicle configured to deliver the product or the service to the user; and
speed adjustment information generation means for generating speed adjustment information for bringing the user vehicle close to the delivery vehicle based on the position information of the user vehicle and the position information of the delivery vehicle, and transmitting the generated speed adjustment information to the user vehicle and the delivery vehicle.

### Supplementary Note 2

The delivery management apparatus according to supplementary note 1, wherein the speed adjustment information includes first speed adjustment information transmitted to the delivery vehicle and second speed adjustment information transmitted to the user vehicle.

### Supplementary Note 3

The delivery management apparatus according to supplementary note 2, wherein the speed adjustment information generation means generates the first speed adjustment information and the second speed adjustment information in accordance with a positional relationship between the user vehicle and the delivery vehicle.

### Supplementary Note 4

The delivery management apparatus according to supplementary note 3, wherein when the delivery vehicle is positioned in front of the user vehicle, the speed adjustment information generation means generates the first speed adjustment information for reducing a traveling speed of the delivery vehicle and generates the second speed adjustment information for making a traveling speed of the user vehicle higher than a traveling speed of the delivery vehicle.

### Supplementary Note 5

The delivery management apparatus according to supplementary note 3 or 4, wherein when the user vehicle is positioned in front of the delivery vehicle, the speed adjustment information generation means generates the second speed adjustment information for reducing a traveling speed of the user vehicle and generates the first speed adjustment information for making a traveling speed of the delivery vehicle higher than a traveling speed of the user vehicle.

### Supplementary Note 6

The delivery management apparatus according to any one of supplementary notes 1 to 5, further including:
request reception means for receiving request information from the user vehicle; and
delivery vehicle specification means for specifying a delivery vehicle that is able to deliver a product or a service to the user vehicle based on the received request information.

### Supplementary Note 7

The delivery management apparatus according to supplementary note 6, wherein
the request information includes information specifying a product or a service desired by a user, and
the delivery vehicle specification means specifies a delivery vehicle that handles the product or the service desired by the user and is not delivering a product or a service to another user as the delivery vehicle that is able to deliver a product or a service to the user vehicle.

### Supplementary Note 8

The delivery management apparatus according to supplementary note 6 or 7, wherein the delivery vehicle specification means specifies the delivery vehicle that is able to deliver a product or a service to the user vehicle based on the request information, the position information of the user vehicle, and the position information of the delivery vehicle.

### Supplementary Note 9

The delivery management apparatus according to any one of supplementary notes 6 to 8, wherein
the delivery vehicle is circulating along a predetermined circulating route, and
the delivery vehicle specification means further specifies the delivery vehicle that is able to deliver a product or a service to the user vehicle based on a destination of the user vehicle and the circulating route of the delivery vehicle.

### Supplementary Note 10

The delivery management apparatus according to any one of supplementary notes 6 to 9, wherein the delivery vehicle specification means estimates at least one of a time required for the specified delivery vehicle to deliver a product or a service to the user vehicle and a place where the specified delivery vehicle delivers a product or a service to the user vehicle.

### Supplementary Note 11

The delivery management apparatus according to any one of supplementary notes 1 to 10, further including order information reception means for receiving order information from the user vehicle and transmitting the received order information to the delivery vehicle.

### Supplementary Note 12

The delivery management apparatus according to supplementary note 11, wherein when the user purchases a product, the order information includes a product purchased by the user, the number of the products, and a delivery and receipt method used for delivery and receipt of the product.

### Supplementary Note 13

A delivery management system including:
a user vehicle in which a user who purchases a product or is provided with a service rides;
a delivery vehicle configured to deliver the product or the service to the user; and
a delivery management apparatus connected to the user vehicle and the delivery vehicle, wherein
the delivery management apparatus includes:
   position information acquisition means for acquiring position information of the user vehicle and position information of the delivery vehicle; and
   speed adjustment information generation means for generating speed adjustment information for bringing the user vehicle close to the delivery vehicle based on the position information of the user vehicle and the position information of the delivery vehicle, and transmitting the generated speed adjustment information to the user vehicle and the delivery vehicle, the user vehicle includes:
   position information transmission means for transmitting position information to the delivery management apparatus; and
   speed adjustment instruction means for receiving the speed adjustment information and instructing the user vehicle to adjust a traveling speed of the user vehicle based on the received speed adjustment information, and
the delivery vehicle includes:
   position information transmission means for transmitting position information to the delivery management apparatus; and
   speed adjustment instruction means for receiving the speed adjustment information and instructing the delivery vehicle to adjust a traveling speed of the delivery vehicle based on the received speed adjustment information.

### Supplementary Note 14

The delivery management system according to supplementary note 13, wherein the speed adjustment information includes first speed adjustment information transmitted to the delivery vehicle and second speed adjustment information transmitted to the user vehicle.

### Supplementary Note 15

The delivery management system according to supplementary note 14, wherein the speed adjustment information generation means generates the first speed adjustment information and the second speed adjustment information in accordance with a positional relationship between the user vehicle and the delivery vehicle.

### Supplementary Note 16

The delivery management system according to any one of supplementary notes 13 to 15, wherein
the delivery vehicle further includes autonomous driving control means for controlling the delivery vehicle to travel autonomously, and
the speed adjustment instruction means of the delivery vehicle instructs the autonomous driving control means of the delivery vehicle to adjust a traveling speed of the delivery vehicle.

### Supplementary Note 17

The delivery management system according to any one of supplementary notes 13 to 16, wherein
the user vehicle further includes autonomous driving control means for controlling the user vehicle to travel autonomously, and
the speed adjustment instruction means of the user vehicle instructs the autonomous driving control means of the user vehicle to adjust a traveling speed of the user vehicle.

### Supplementary Note 18

A delivery vehicle configured to deliver, to a user, a product purchased by the user or a service provided to the user, the delivery vehicle including:
position information transmission means for transmitting position information to a delivery management apparatus; and
speed adjustment instruction means for receiving, from the delivery management apparatus, speed adjustment information for bringing a user vehicle in which the user who purchases the product or is provided with the service rides close to the delivery vehicle, and instructing the delivery vehicle to adjust a traveling speed of the delivery vehicle based on the received speed adjustment information.

### Supplementary Note 19

The delivery vehicle according to supplementary note 18, further including autonomous driving control means for controlling the delivery vehicle to travel autonomously, wherein the speed adjustment instruction means instructs the autonomous driving control means to adjust a traveling speed of the delivery vehicle.

### Supplementary Note 20

A user vehicle in which a user who purchases a product or is provided with a service rides, the user vehicle including:
position information transmission means for transmitting position information to a delivery management apparatus; and
speed adjustment instruction means for receiving, from the delivery management apparatus, speed adjustment information for bringing a delivery vehicle configured to deliver the product or the service to the user close to the user vehicle, and instructing the user vehicle to adjust a traveling speed of the user vehicle based on the received speed adjustment information.

### Supplementary Note 21

The user vehicle according to supplementary note 20, further including autonomous driving control means for controlling the user vehicle to travel autonomously, wherein the speed adjustment instruction means instructs the autonomous driving control means to adjust a traveling speed of the user vehicle.

### Supplementary Note 22

A delivery management method including:
acquiring position information of a user vehicle in which a user who purchases a product or is provided with a service rides, and position information of a delivery vehicle configured to deliver the product or the service to the user; and
generating speed adjustment information for bringing the user vehicle close to the delivery vehicle based on the position information of the user vehicle and the position information of the delivery vehicle, and transmitting the generated speed adjustment information to the user vehicle and the delivery vehicle.

### Supplementary Note 23

A non-transitory computer readable medium storing a program for causing a computer apparatus to execute processing including:
acquiring position information of a user vehicle in which a user who purchases a product or is provided with a service rides, and position information of a delivery vehicle configured to deliver the product or the service to the user; and
generating speed adjustment information for bringing the user vehicle close to the delivery vehicle based on the position information of the user vehicle and the position information of the delivery vehicle, and transmitting the generated speed adjustment information to the user vehicle and the delivery vehicle.

### REFERENCE SIGNS LIST

10: DELIVERY MANAGEMENT SYSTEM
20: DELIVERY MANAGEMENT APPARATUS
21: POSITION INFORMATION ACQUISITION MEANS
22: SPEED ADJUSTMENT INFORMATION GENERATION MEANS
30: DELIVERY VEHICLE
31: POSITION INFORMATION TRANSMISSION MEANS
32: SPEED ADJUSTMENT INSTRUCTION MEANS
50: USER VEHICLE
51: POSITION INFORMATION TRANSMISSION MEANS
52: SPEED ADJUSTMENT INSTRUCTION MEANS
100: DELIVERY MANAGEMENT SYSTEM
110: DELIVERY MANAGEMENT APPARATUS
111: POSITION INFORMATION ACQUISITION UNIT
112: REQUEST RECEPTION UNIT
113: DELIVERY VEHICLE SPECIFICATION UNIT
114: ORDER INFORMATION RECEPTION UNIT
115: SPEED ADJUSTMENT INFORMATION GENERATION UNIT
116: COMMUNICATION UNIT
130: DELIVERY VEHICLE
131: POSITION MEASUREMENT UNIT
132: ORDER RECEPTION UNIT
133: COMMUNICATION UNIT
134: SPEED ADJUSTMENT INSTRUCTION UNIT
135: AUTONOMOUS DRIVING CONTROL UNIT
150: USER VEHICLE
151: POSITION MEASUREMENT UNIT
152: PRODUCT ORDER UNIT
153: COMMUNICATION UNIT
154: SPEED ADJUSTMENT INSTRUCTION UNIT
155: AUTONOMOUS DRIVING CONTROL UNIT
210: DRONE
220: EXTENDABLE ARM
500: COMPUTER APPARATUS
510: CPU
520: STORAGE UNIT
530: ROM
540: RAM
550: COMMUNICATION INTERFACE
560: USER INTERFACE

What is claimed is:

1. A delivery management apparatus comprising:
at least one memory storing instructions; and
at least one processor configured to execute the instructions to:
acquire position information of a user vehicle in which a user who purchases a product or is provided with a service rides, and position information of a delivery vehicle configured to deliver the product or the service to the user; and
generate speed adjustment information for bringing the user vehicle close to the delivery vehicle based on the position information of the user vehicle and the position information of the delivery vehicle, and transmit the generated speed adjustment information to the user vehicle and the delivery vehicle.

2. The delivery management apparatus according to claim 1, wherein the speed adjustment information includes first speed adjustment information transmitted to the delivery vehicle and second speed adjustment information transmitted to the user vehicle.

3. The delivery management apparatus according to claim 2, wherein the at least one processor is configured to execute the instructions to generate the first speed adjustment information and the second speed adjustment information in accordance with a positional relationship between the user vehicle and the delivery vehicle.

4. The delivery management apparatus according to claim 3, wherein when the delivery vehicle is positioned in front of the user vehicle, the at least one processor is configured to execute the instructions to generate the first speed adjustment information for reducing a traveling speed of the delivery vehicle and generate the second speed adjustment information for making a traveling speed of the user vehicle higher than a traveling speed of the delivery vehicle.

5. The delivery management apparatus according to claim 3, wherein when the user vehicle is positioned in front of the delivery vehicle, the at least one processor is configured to execute the instructions to generate the second speed adjustment information for reducing a traveling speed of the user vehicle and generate the first speed adjustment information for making a traveling speed of the delivery vehicle higher than a traveling speed of the user vehicle.

6. The delivery management apparatus according to claim 1, wherein the at least one processor is further configured to execute the instructions to:
receive request information from the user vehicle; and
specify a delivery vehicle that is able to deliver a product or a service to the user vehicle based on the received request information.

7. The delivery management apparatus according to claim 6, wherein
the request information includes information specifying a product or a service desired by a user, and
the at least one processor is configured to execute the instructions to specify a delivery vehicle that handles the product or the service desired by the user and is not delivering a product or a service to another user as the delivery vehicle that is able to deliver a product or a service to the user vehicle.

8. The delivery management apparatus according to claim 6, wherein the at least one processor is configured to execute the instructions to specify the delivery vehicle that is able to deliver a product or a service to the user vehicle based on the request information, the position information of the user vehicle, and the position information of the delivery vehicle.

9. The delivery management apparatus according to claim 6, wherein
the delivery vehicle is circulating along a predetermined circulating route, and
the at least one processor is configured to execute the instructions to specify the delivery vehicle that is able to deliver a product or a service to the user vehicle based on a destination of the user vehicle and the circulating route of the delivery vehicle.

10. The delivery management apparatus according to claim 6, wherein the at least one processor is configured to execute the instructions to estimate at least one of a time required for the specified delivery vehicle to deliver a product or a service to the user vehicle and a place where the specified delivery vehicle delivers a product or a service to the user vehicle.

11. The delivery management apparatus according to claim 1, the at least one processor is further configured to execute the instructions to receive order information from the user vehicle and transmit the received order information to the delivery vehicle.

12. The delivery management apparatus according to claim 11, wherein when the user purchases a product, the order information includes a product purchased by the user, the number of the products, and a delivery and receipt method used for delivery and receipt of the product.

13. A delivery management system comprising:
a user vehicle in which a user who purchases a product or is provided with a service rides;
a delivery vehicle configured to deliver the product or the service to the user; and
a delivery management apparatus connected to the user vehicle and the delivery vehicle, wherein
the delivery management apparatus comprises:
at least one first memory storing first instructions; and
at least one first processor configured to execute the instructions to:
acquire position information of the user vehicle and position information of the delivery vehicle; and
generate speed adjustment information for bringing the user vehicle close to the delivery vehicle based on the position information of the user vehicle and the position information of the delivery vehicle, and transmit the generated speed adjustment information to the user vehicle and the delivery vehicle,
the user vehicle comprises:
at least one second memory storing second instructions; and
at least one second processor configured to execute the instructions to:
transmit position information of the user vehicle to the delivery management apparatus; and
receive the speed adjustment information and instruct the user vehicle to adjust a traveling speed of the user vehicle based on the received speed adjustment information, and
the delivery vehicle comprises:
at least one third memory storing third instructions; and
at least one third processor configured to execute the instructions to:
transmit position information of the delivery vehicle to the delivery management apparatus; and
receive the speed adjustment information and instruct the delivery vehicle to adjust a traveling speed of the delivery vehicle based on the received speed adjustment information.

14. The delivery management system according to claim 13, wherein the speed adjustment information includes first speed adjustment information transmitted to the delivery vehicle and second speed adjustment information transmitted to the user vehicle.

15. The delivery management system according to claim 14, wherein the at least one first processor is configured to execute the first instructions to generate the first speed adjustment information and the second speed adjustment information in accordance with a positional relationship between the user vehicle and the delivery vehicle.

16. The delivery management system according to claim 13, wherein
the at least one third processor is further configured to execute the third instructions to control the delivery vehicle to travel autonomously, and
the at least one third processor is configured to execute the third instructions to control autonomous driving of the delivery vehicle to adjust a traveling speed of the delivery vehicle.

17. The delivery management system according to claim 13, wherein
the at least one second processor is further configured to execute the second instructions to control the user vehicle to travel autonomously, and
the at least one second processor is configured to execute the second instructions to control autonomous driving of the user vehicle to adjust a traveling speed of the user vehicle.

18.-21. (canceled)

22. A delivery management method comprising:
acquiring position information of a user vehicle in which a user who purchases a product or is provided with a service rides, and position information of a delivery vehicle configured to deliver the product or the service to the user; and
generating speed adjustment information for bringing the user vehicle close to the delivery vehicle based on the position information of the user vehicle and the position information of the delivery vehicle, and transmitting the generated speed adjustment information to the user vehicle and the delivery vehicle.

23. (canceled)
